(19) United States
(12) Patent Application Publication
(10) Pub. No.: US 2004/0188356 A1
(43) Pub. Date: Sep. 30, 2004

(54) System for producing large particle precipitates

(75) Inventor: Frederick J. Haydock, Murray, UT (US)

Correspondence Address: Lloyd W. Sadler, Parsons Behle & Latimer, 201 South Main Street, Suite 1800, Salt Lake City, UT, 84111, US

(73) Assignee: Haydock Intellectual Properties, L.L.C., Murray, UT (US)

(21) Appl. No.: 10/396,984

(22) Filed: Mar. 24, 2003

(51) Int. Cl. C02F 1/52

(52) U.S. Cl. 210/702

(57) ABSTRACT

A method and system for the creation of large particle precipitates to facilitate the filtering of particles from a flow of water or other liquid that makes use of a venturi device for mixing, compressing and diffusing chemicals with the flow for treatment. This invention provides a quick, efficient and economical method of removing suspended or dissolved particles from a liquid media and does so without requiring complex expensive controls and equipment.

### BACKGROUND OF INVENTION

1. Field of the Invention

This invention relates to methods and systems for filtration. More specifically, this invention relates to methods and systems for creating large particle precipitates to enhance effective filtration.

2. Description of Related Art

A variety of filtration systems are well known in the art. Even Venturi-type siphons have been used for a number of years to inject and mix chemicals in water or other liquid treatment applications. However, generally, prior systems have failed to employ both a Venturi and a back-pressure device to produce large particle precipitates by coagulation or chelating.

Although these documents may not qualify as “prior art” to the present invention, the reader is referred to the following U.S. patent documents for general background material. Each of these documents is hereby incorporated by reference in its entirety for the material contained therein.

U.S. Pat. No. 3,939,525 describes the removal of sulfur dioxide from stack gases with phosphate slimes.

U.S. Pat. No. 3,944,401 describes a process for the removal of gaseous impurities from exhaust gases of a contact-process plant.

U.S. Pat. No. 3,954,403 describes the removal of phosphates in a drain line of a laundry tub by chemical precipitation.

U.S. Pat. No. 3,958,985 describes an extraction method for non-ferrous metals.

U.S. Pat. No. 3,975,168 describes a process for gasifying carbonaceous solids and removal of toxic constituents from aqueous effluents.

U.S. Pat. No. 3,990,993 describes a method for increasing particle size.

U.S. Pat. No. 3,995,005 describes a process for treatment of flue gases to remove acid gases, boron compounds and particulates.

U.S. Pat. No. 3,996,133 describes a process for reclaiming calcium values from the solid residual of incineration of sewage.

U.S. Pat. No. 4,006,066 describes a method and apparatus for the treatment of exhaust-gases in the electrolytic production of aluminum.

U.S. Pat. No. 4,028,071 describes a method for removing particulate pollutants from stack gases.

U.S. Pat. No. 4,035,228 describes a process and apparatus for treating concentrated alkali metal-containing waste liquor.

U.S. Pat. No. 4,058,459 describes an apparatus, which filters moisture and solid contaminants from liquids.

U.S. Pat. No. 4,062,990 describes a system for preventing water pollution in surface treatment of metals.

U.S. Pat. No. 4,065,274 describes a pollution control system for reducing the presence of fine aerosol particles in stack gases.

U.S. Pat. No. 4,067,703 describes a method and apparatus for separating particulate matter in solid or liquid form from a gas stream.

U.S. Pat. No. 4,081,508 describes a process for reducing flue gas contaminants from fluid cracking catalyst regenerators.

U.S. Pat. No. 4,083,944 describes a continuous process for removing sulfur dioxide from stack gases.

U.S. Pat. No. 4,085,030 describes a continuous process for recovery of values contained in a solid carbonaceous material.

U.S. Pat. No. 4,093,430 describes an apparatus for ionizing gases using a venturi.

U.S. Pat. No. 4,113,840 describes a process for the removal of sulfur dioxide from exhaust flue gases.

U.S. Pat. No. 4,116,488 describes an in-situ mining method and apparatus.

U.S. Pat. No. 4,134,755 describes a process and apparatus for recycling iron material components of dusts discharged from iron manufacturing furnaces.

U.S. Pat. No. 4,153,514 describes a process for the recovery of chemical values from waste solids.

U.S. Pat. No. 4,162,680 describes an apparatus for inhibiting water pollution in surface treatment of metals.

U.S. Pat. No. 4,194,888 describes an electrostatic precipitator having an inner electrode extending along the axis of a tubular outer electrode.

U.S. Pat. No. 4,203,837 describes a process for removal of discrete particulates from liquids by foam floatation.

U.S. Pat. No. 4,209,912 describes a process for the drying of resinous materials.

U.S. Pat. No. 4,233,274 describes a method of extracting and recovering mercury from gases.

U.S. Pat. No. 4,244,709 describes a high intensity ionization-electrostatic precipitation system for particle removal and method of operation.

U.S. Pat. No. 4,247,307 describes a high intensity ionization-wet collection method and apparatus.

U.S. Pat. No. 4,251,234 describes a high intensity ionization-electrostatic precipitation system for particle removal.

U.S. Pat. No. 4,266,951 describes a particle scrubber and related method for removing finely divided contaminants from a gas stream.

U.S. Pat. No. 4,284,609 describes a process for the condensation cleaning of particulate laden gases.

U.S. Pat. No. 4,294,588 describes a method for passing an additive across a gas stream in an electrostatic precipitator to improve particle removal.

U.S. Pat. No. 4,399,118 describes a process for the recovery of substantially anhydrous zirconium tetrafluoride from an aqueous solution.

U.S. Pat. No. 4,401,468 describes a cyanide process for removing precious metals from ore.

U.S. Pat. No. 4,406,696 describes a process for recovering of metals from solutions of metal salts.

U.S. Pat. No. 4,504,017 describes an apparatus for comminuting materials to extremely fine size.

U.S. Pat. No. 4,534,955 describes a sulfur extraction process.

U.S. Pat. No. 4,541,844 describes a method and apparatus for the removal of particulate matter from a gas stream.

U.S. Pat. No. 4,559,146 describes a method of clarifying proteanaceous wastewater.

U.S. Pat. No. 4,619,608 describes a process for removal of pollutants from waste gas emissions.

U.S. Pat. No. 4,619,670 describes an apparatus for dielectrophoretically enhanced particle collection.

U.S. Pat. Nos. 4,747,958, 4,818,416, 4,877,524 and 4,882,072 describe methods and apparatus for treating bodies of water.

U.S. Pat. No. 4,790,945 describes a method of removing hydrogen selenide.

U.S. Pat. No. 4,871,251 describes an apparatus and method for particle analysis.

U.S. Pat. No. 5,063,789 describes a high velocity gas particulate sampling system.

U.S. Pat. No. 5,084,072 describes a wet wall electrostatic precipitator with liquid recycle.

U.S. Pat. No. 5,096,580 describes a system and method for removing iron from potable water by oxidation.

U.S. Pat. No. 5,234,669 describes methods for treating smelter flue dust and other smelter by-produces.

U.S. Pat. No. 5,265,545 describes a method of treatment of waste material.

U.S. Pat. Nos. 5,286,466 and 5,302,361 describe a packed mass transfer tower for establishing intimate gas-liquid contact and efficient mass transfer.

U.S. Pat. No. 5,296,205 describes a multi-bed mass transfer column with mobile packing.

U.S. Pat. No. 5,399,833 describes a method for vitrification of fine particulate matter.

U.S. Pat. No. 5,427,608 describes a method and apparatus for separating solid and/or liquid particles from a gas stream.

U.S. Pat. No. 5,476,994 describes a process for extracting metals from sediment.

U.S. Pat. No. 5,497,710 describes an apparatus for vitrification of fine particulate matter.

U.S. Pat. No. 5,577,522 describes a system for on-site decontamination of solid and hazardous waste.

U.S. Pat. No. 5,690,898 describes a method for treating effluent from a supercritical water oxidation reactor.

U.S. Pat. No. 5,824,274 describes a water purifier and surface sanitizer.

U.S. Pat. No. 5,868,495 describes a method for treating fluent materials.

U.S. Pat. No. 5,879,546 describes a water purification and recovery system.

U.S. Pat. No. 6,238,459 B1 describes a method and apparatus for ultra-high particulate collection of sub-micron aerosols.

U.S. Pat. Nos. 6,270,679 B1 and 6,274,045 B1 describe methods for recovering and separating metals from waste streams.

U.S. Pat. No. 6,398,968 B1 describes methods for the pressurized stabilized removal of contaminants from solution.

U.S. Pat. No. 6,475,462 B1 describes a process and apparatus for treating particulate matter.

U.S. Pat. No. 6,520,259 B1 describes a method and apparatus for fluid entrainment.

### SUMMARY OF INVENTION

It is desirable to provide a method and system for the filtration of suspended or dissolved particles in a liquid media. It is particularly desirable to provide a method and system for such filtration that enhances the effectiveness of the filtration by creating large particle precipitates during coagulation, thereby reducing the need for expensive filtration media to remove particles smaller than three microns in size. Since it is desirable to provide a treatment process, which can remove as many contaminants as quickly, efficiently and economically as possible especially for the treatment of and since the time required for chemical processing often hinders, delays and/or increases the expense of processing.

Accordingly, it is an object of this invention to provide a method and system for the filtration of particles in a liquid medium that creates large particle precipitates during coagulation to enhance and facilitate filtration.

It is another object of this invention to provide a method and system for the filtration of particles in a liquid medium that can remove micron and sub-micron sized particles.

It is a further object of this invention to provide a method and system for the filtration of particles in a liquid medium that is compatible with drinking water treatment.

It is a still further object of this invention to provide a method and system for the filtration of particles in a liquid medium avoids lengthy reaction retention times.

Another object of this invention is to provide a method and system for the filtration of particles in a liquid medium that minimizes uncontrolled particle sizes.

A further object of this invention is to provide a method and system for the filtration of particles in a liquid medium that uses a venturi, siphon and backpressure device to create precipitates of large dimensions quickly, efficiently and economically.

Additional objects, advantages and other novel features of this invention will be set forth in part in the description that follows and in part will be apparent to those skilled in the art upon examination of the following or may be learned with the practice of the invention. The objects and advantages of this invention may be realized and attained by means of the instrumentalities and combinations particularly pointed out in the appended claims. Still other objects of the present invention will become readily apparent to those skilled in the art from the following description wherein there is shown and described present preferred embodiments of the invention, simply by way of illustration of the best modes currently known to carry out this invention. As it will be realized, this invention is capable of other different embodiments, and its several details, and specific steps and components, are capable of modification in various aspects without departing from the invention. Accordingly, the drawings and descriptions should be regarded as illustrative in nature and not as restrictive.

### BRIEF DESCRIPTION OF DRAWINGS

The accompanying drawings incorporated in and forming a part of the specification, illustrate embodiments of the present invention. Some, although not all, alternative embodiments are described in the following description.

In the drawings:

FIG. 1 is a system diagram of the components and flow of the present embodiment of this invention.

FIG. 2 is a process flow chart of the present method of this invention.

Reference will now be made in detail to the present preferred embodiments of the invention, examples of which are illustrated in the accompanying drawings.

### DETAILED DESCRIPTION

This invention is a method and system for the treatment of wastewater or other liquid media. In particular, this invention provides for the coagulation and filtration of suspended or dissolved particles in the liquid. Chemicals and contaminated liquid or liquids are compressed and mixed in a venturi device. As the mixture exits the venturi, it expands and tends to create coagulants having very large particle size, which are substantially easier and more effectively filtered. In a typical waste water system a substantial amount of the particles in the flow are 3 microns or smaller in size. By creating large particle precipitates (typically greater than 10 microns and often as large as several hundred microns in size) from these very small particles, this system and method facilitates subsequent filtration and reduces the need for expensive filtration media to remove the very small particles.

Precipitation and filtration is used throughout the world for the treatment of drinking water, process, industrial, wastewater streams and sewage waters. In many of these applications the suspended solids, entrained and dissolved particles are presently removed by chemical processes that use coagulation/precipitation and filtration technologies. The intent of the treatment process is to remove as many contaminants as quickly, efficiently and economically as possible. Unfortunately, the efficacy of many of the prior processes is reduced by the time required for a chemical reaction to occur and for the precipitate to be formed. Typically, these prior systems require an expensive and complex diversity of controls and equipment to treat and process small or large volumes of waste water in order to remove the suspended and dissolved particles before the industrial or process treated waters can be legally discharged. Large holding or settling tanks and ponds are also often required in these prior systems to allow sufficient time for coagulating chemicals to react and bond to the contaminants.

Unlike the prior processes, this present invention produces large particle precipitates by compression of the liquid/water matrix and the injected chemicals at a venturi throat. As the venturi compresses the entrained or dissolved gases in the liquid matrix, it mixes and diffuses the chelating or coagulation chemical thoroughly by surrounding the suspended solids or dissolved contaminants in a liquid matrix. The compression of mechanically introduced or naturally entrained gases in water or other liquids produces a binding reaction between a chelating agent or coagulation chemicals to bind suspended solids or dissolved contaminants in the form of a precipitate. As the fluid exits the throat of the venturi it expands under pressure producing and binding the entrained materials in the form of a precipitate. A backpressure device or in-line mixer reduces the turbulent flow from the venturi and stabilizes the composition of particles ranging in size from 10 to 200 microns. The process of this invention does not require a pressurization cycle since the pressure is produced at the throat or entrance to the venturi. This invention compresses or squeezes the injected chemicals, whether using chelating or using coagulating chemicals, to the reactive surface areas of the suspended or dissolved particles/elements in solutions. The precipitate is formed in the compression cycle and is stabilized under pressure as the chemically bound solution is released and expands from the venturi throat. The resulting formed precipitates are relatively very large and therefore easy to filter through a standard filtration medium.

An important improvement in water treatment is creating large particle precipitates quickly, efficiently and economically for filtering. This invention solves the problems of lengthy reaction retention times, uncontrolled particle sizes and the need for complex and expensive equipment to produce precipitates by using a venturi/siphon and back pressure device to create precipitates of large relative size quickly, efficiently and economically.

This present invention can be used in industrial, commercial, municipal, governmental, wastewater, sewage treatment, or drinking water applications that require chelating or coagulation and precipitation chemistry. This invention is particularly useful in precipitation, coagulation and chelating of various minerals and metals in process and in industrial wastewater and potable water applications, where economic and rapid formation of readily filterable precipitates is desired. This invention is also useful in the food processing industry for reducing BOD and COD levels by coagulating, precipitating and filtering suspended solids, fats, oils, flours, starches, poultry, fish and meat by-products and other waste or by-products quickly and economically. The coagulation and chelating chemicals can be injected as liquids or as slurries into the system, forming precipitates containing bound up minerals and metals from mining process waters, industrial or municipal waste water streams.

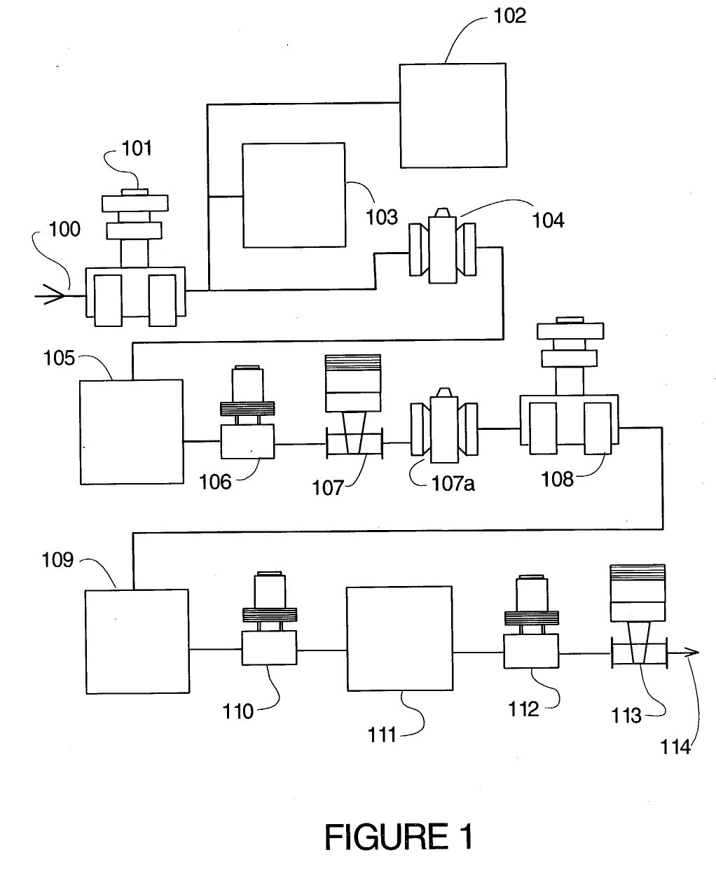

Referring to FIG. 1, which is a system diagram of the components and flow for the present embodiment of the invention. Water or other liquids 100 to be processed are received by the system. Typically, this water or other liquid 100 is provided by being pumped from tanks or through piping to a valve 101 at the inlet of this system. Chemicals, typically provided by a first 102 and second 103 chemical tank are introduced to a first venturi device 104 at siphon ports on the venturi 104. The chemicals may also, alternatively, be injected in predetermined amounts at the venturi 104 siphon ports by use of anti-siphening valves. As the liquid is drawing into the venturi 104, the chemicals are pulled into the contaminated effluent stream and compressed at the throat of the venturi 104. Also at the venturi 104 throat the chemicals and entrained gases in the solution are thoroughly diffused and the precipitation reaction begins. A reaction tank 105 is provided to receive the output of the venturi 104 for stabilization of the solution wherein it is converted to a laminar flow. A back-pressure device comprising a valve 106 and a pump 107 maintain the functional integrity of the venturi system by adding friction and pressure to the venturi and allowing the precipitate in the reaction tank 105 to maintain its stability and size by reducing particle shearing. A second venturi 107a receives the laminar flow, the output of which is received by a valve 108 which controls the flow into a first 109 and, via a third valve 110 to a second filter tank 111. The filter tanks 110, 111 remove the created large particles, using conventional and/or sophisticated filters and membranes. Under control of a final valve 112 and pump 113 the system produces a flow having a high degree of particle filtration.

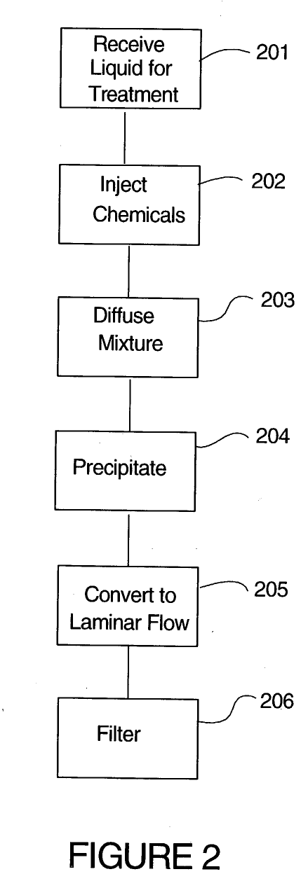

FIG. 2 shows the process for the present method of the invention. The waste liquid flow is received 201. Chemicals are injected 202 into a venturi. The resulting mixture is diffused 203, producing a large particle precipitate 204. The compressed and diffused flow is converted 205 to a laminar flow. The laminar flow is filtered 206, typically and preferably using a two-step filter, removing the created large particle precipitates.

While the invention has been described with respect to certain specific embodiments, compositions and steps, it will be appreciated that many modifications and changes may be made by those skilled in the art without departing from the invention. It is intended, therefore, by the appended claims to cover all such modifications and changes as may all within the true spirit and scope of the invention.

1. A system for producing large particle precipitants, comprising:
(A) a received flow for treatment;
(B) a first coagulation chemical;
(C) a venturi device receiving said flow for treatment and said first coagulation chemical and producing a diffused solution;
(D) a reaction tank receiving said diffused solution wherein a precipitation reaction occurs; and
(E) a backpressure device maintaining functional integrity of the precipitated mixture forming a laminar flow.

2. A system for producing large particle precipitates, as recited in claim 1, further comprising a second chemical introduced in said venturi.

3. A system for producing large particle precipitates, as recited in claim 1, wherein said backpressure device, further comprises a valve and a pump.

4. A system for producing large particle precipitates, as recited in claim 1, further comprising a filter system receiving said laminar flow.

5. A system for producing large particle precipitates, as recited in claim 4, wherein said filter system further comprises a filtering tank.

6. A method for producing large particle precipitates, comprising:
(A) receiving a liquid for treatment into a venturi device;
(B) injecting chemicals into said venturi device forming a chemical-treatment liquid mixture;
(C) diffusing said chemical-treatment liquid mixture;
(D) precipitating said diffused mixture;
(E) converting said precipitated mixture into a laminar flow; and
(F) filtering precipitants from said laminar flow.

7. A method for producing large particle precipitates, as recited in claim 6, wherein injection of chemicals further comprises injecting a plurality of chemicals.

8. A method for producing large particle precipitates, as recited in claim 6, wherein said diffusion occurs in the throat of said venturi.

9. A method for producing large particle precipitates, as recited in claim 6, wherein said conversion to a laminar flow is performed with a backpressure device.

10. A method for producing large particle precipitates, as recited in claim 6, wherein said filtering further comprises a first and a second filter step.
